(19) United States
(12) Patent Application Publication
(10) Pub. No.: US 2017/0246647 A1
(43) Pub. Date: Aug. 31, 2017

(54) PHOTOLUMINESCENT ACTIVATOR APPARATUS, PHOTOLUMINESCENT COMPOSITION, METHOD OF MAKING AND USING THE SAME

(71) Applicant: Jaclyn BRACKETT, Colorado Springs, CO (US)

(72) Inventor: Jaclyn BRACKETT, Colorado Springs, CO (US)

(21) Appl. No.: 15/519,725

(22) PCT Filed: Oct. 21, 2015
(86) PCT No.: PCT/US2015/056702

§ 371 Date: Apr. 17, 2017

Related U.S. Application Data
(60) Provisional application No. 62/066,653, filed on Oct. 21, 2014.

(51) Int. Cl. B05B 11/00; A46B 11/00; F21V 9/16

(52) U.S. Cl. CPC B05B 11/3001; F21V 9/16; A46B 11/0072; F21Y 2115/10

(57) ABSTRACT

The present invention generally relates to a photoluminescent activator apparatus, a photoluminescent composition, a method of making, and a method of using the activator and composition, and more particularly to a system and method to illuminate objects and/or materials. Accordingly, the invention is directed to photoluminescent activator, photoluminescent composition, method of making and using the same that substantially obviates one or more of the problems due to limitations and disadvantages of the related art.

The present application claims the benefit of U.S. Provisional Patent Application No. 62/066,653, filed Oct. 21, 2014, the above-identified provisional patent application is fully incorporated herein by reference.

### BACKGROUND OF THE INVENTION

Field of the Invention

The present invention generally relates to a photoluminescent activator apparatus, a photoluminescent composition, a method of making, and a method of using the activator and composition, and more particularly to a system and method to illuminate objects and/or materials.

Discussion of the Related Art

In the related art there are different varieties of luminescent products, such as, chemiluminescence, bioluminescence, fluorescence, and photoluminescent products. Chemiluminescence products, such as glowsticks, and bioluminescence products use harsh chemicals and/or living organisms to emit light which are not recommended for direct human contact or prolonged skin exposure, or could causes biohazard concerns. With phosphorescence and fluorescence, the energy comes from exposure to electromagnetic radiation, as the material absorbs the UV light, electrons change energy shells and are able to give off light without heat. Fluorescence dyes, powders, paints, etc. require a continuous source of excitation to emit light and photoluminescent materials have the ability to store energy garnered via exposure to electromagnetic radiation and re-emit that stored energy over a course of time. Typically, an excited photoluminescent material has a very short timeline to re-emit, e.g., a logarithmic discharge timeline, the emission starts out at a certain degree of brightness and slowly decays. Because of these problems, applications for luminescent fluids have been very limited because of these constraints.

Embodiments of the invention are directed towards one or more improvements of the related art.

### SUMMARY OF THE INVENTION

Accordingly, the invention is directed to photoluminescent activator, photoluminescent composition, method of making and using the same that substantially obviates one or more of the problems due to limitations and disadvantages of the related art.

An advantage of the invention is to provide a single system to easily eject excited photoluminescent fluid without the use of an external electromagnetic radiation source.

Another advantage of the invention is to provide a mixed powder composition to provide a non-toxic to plants and animals, non-radioactive, non-staining on a wide variety of materials including fabric, etc. photoluminescent fluid or semisolid for a wide variety of usages, including skin contact.

Yet another advantage of the invention is it is capable of reactivating the photoluminescent composition after projected from the device.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, an apparatus for projecting an activated photoluminescent including a container including a chamber for storing the photoluminescent composition, an aperture for receiving the photoluminescent composition, and optionally, a fluid emitting device coupled to the aperture and a light source arranged within the apparatus and configured to activate the photoluminescent composition in the chamber.

In another aspect of the present invention, a method of activating a photoluminescent composition within a photoluminescent activating apparatus including a method of obtaining a photoluminescent activating apparatus including a container including a chamber for storing the photoluminescent composition, an aperture for receiving the photoluminescent composition, and optionally, a fluid emitting device coupled to the aperture and a light source arranged to emit light within a portion of the container configured to activate the photoluminescent composition in the chamber; providing the photoluminescent composition into the chamber through at least a portion of the aperture; and turning on a power source to activate a light source.

In yet another aspect an embodiment of the invention is directed towards an apparatus for generating and discharging non-toxic, nonradioactive luminescent fluid/semisolid that is safe for human contact. The photoluminescent composition, e.g., fluid/semisolid, uses large photoluminescent particles, includes at least one phosphor, suspended in a binder or binder/water mixture to the viscosity needed for the specific application. Upon exposure to ultraviolet light or sunlight results in the fluid/semisolid being able to emit a bright glow for extended periods of time. A fluid carrier vehicle is designed with an electromagnetic radiation device to access the fluid/semisolid within the body. The fluid carrier vehicle is an open system capable of releasing the fluid or semisolid.

This Summary section is neither intended to be, nor should be, construed as being representative of the full extent and scope of the present disclosure. Additional benefits, features and embodiments of the present disclosure are set forth in the attached figures and in the description herein below, and as described by the claims. Accordingly, it should be understood that this Summary section may not contain all of the aspects and embodiments claimed herein.

Additionally, the disclosure herein is not meant to be limiting or restrictive in any manner. Moreover, the present disclosure is intended to provide an understanding to those of ordinary skill in the art of one or more representative embodiments supporting the claims. Thus, it is important that the claims be regarded as having a scope including constructions of various features of the present disclosure insofar as they do not depart from the scope of the methods and apparatuses consistent with the present disclosure (including the originally filed claims). Moreover, the present disclosure is intended to encompass and include obvious improvements and modifications of the present disclosure.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1A illustrates an exemplary perspective view of a photoluminescent activator apparatus according to an embodiment of the invention;

FIG. 1B illustrates a top view of the photoluminescent activator apparatus according to FIG. 1A;

FIG. 1C illustrates a cross-sectional view of the photoluminescent activator apparatus according to FIG. 1B along line A-A′;

FIG. 2 illustrates an exemplary light source circuit according to an embodiment of the invention;

FIG. 3A illustrates an exemplary perspective view of a photoluminescent activator apparatus according to another embodiment of the invention;

FIG. 3B illustrates a top view of the photoluminescent activator apparatus according to FIG. 3A;

FIG. 3C illustrates a cross sectional view of the photoluminescent activator apparatus according to FIG. 2B along the line B-B′;

FIG. 3D illustrates a cross sectional view of the photoluminescent activator apparatus according to FIG. 2B along the line A-A′;

FIG. 4A illustrates an exemplary perspective view of a photoluminescent activator apparatus according to another embodiment of the invention;

FIG. 4B illustrates a top view of the photoluminescent activator apparatus according to FIG. 4A;

FIG. 4C illustrates a cross sectional view of the photoluminescent activator apparatus according to FIG. 4B along the line A-A′;

FIG. 4D illustrates a cross sectional view of the photoluminescent activator apparatus according to FIG. 4B along the line B-B;

FIG. 5 illustrates an exemplary side view of a fluid emitting device according to another embodiment of the invention;

FIG. 6A illustrates an exemplary perspective view of a photoluminescent activator apparatus according to another embodiment of the invention;

FIG. 6B illustrates a top view of the photoluminescent activator apparatus according to FIG. 6A;

FIG. 6C illustrates a cross sectional view of the photoluminescent activator apparatus according to FIG. 6B along line A-A′;

FIG. 7A illustrates an exemplary perspective view of a photoluminescent activator apparatus according to another embodiment of the invention;

FIG. 7B illustrates a top view of the photoluminescent activator apparatus according to FIG. 7A;

FIG. 7C illustrates a cross sectional view of the photoluminescent activator apparatus according to FIG. 7B along line A-A′;

FIG. 7D illustrates a side view of the photoluminescent activator apparatus according to FIG. 7A;

FIG. 7E illustrates a cross sectional view of the photoluminescent activator apparatus according to FIG. 7D along line C-C′;

FIG. 7F illustrates a cross sectional view of the photoluminescent activator apparatus according to FIG. 7D along line B-B′;

FIG. 7G illustrates a top view of the photoluminescent activator apparatus according to FIG. 7A with another aperture head;

FIG. 7H illustrates a cross sectional view of the photoluminescent activator apparatus according to FIG. 7G along line A-A′;

FIG. 8A illustrates an exemplary perspective view of a photoluminescent activator apparatus according to another embodiment of the invention;

FIG. 8B illustrates a top view of the photoluminescent activator apparatus according to FIG. 8A;

FIG. 8C illustrates a cross sectional view of the photoluminescent activator apparatus according to FIG. 8B along line A-A′; and

FIG. 9 illustrates the illumination and duration of three off the shelf products and four photoluminescent compositions according to embodiments of the invention.

### DETAILED DESCRIPTION OF THE ILLUSTRATED EMBODIMENTS

For the purposes of promoting an understanding of the principles of the present disclosure, reference will now be made to the exemplary embodiments illustrated in the drawing(s), and specific language will be used to describe the same.

Appearances of the phrases an “embodiment,” an “example,” or similar language in this specification may, but do not necessarily, refer to the same embodiment, to different embodiments, or to one or more of the figures. The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps unless explicitly stated otherwise.

In order to more fully appreciate the present disclosure and to provide additional related features, the following references are incorporated therein by reference in their entirety:

(1) U.S. Pat. No. 4,757,625 by Watkins, which discloses an article for producing an interesting visual effect is disclosed. The article has a translucent or transparent conduit extending in a loop defining a path of fluid flow. A portion of the loop is contained in an opaque container and a portion extends out of the container. A pump moves a stream of liquid containing phosphorescent particles through the conduit. A light in the container charges the particles immediately prior to their movement through the portion of the conduit outside the container where the glow from the moving particles are observable through the conduit wall. Continued operation continuously moves the particles past the light for recharging.

(2) U.S. Pat. No. 5,498,280 by Fistner, et al., which discloses a phosphorescent and fluorescent marking composition, e.g., a crayon, comprising both high and low molecular weight polyethylene glycols in combination with phosphorescent and fluorescent pigments. The composition advantageously preferably further includes at least one filler, which preferably includes a water-miscible filler, a water-soluble surfactant, and a plasticizer.

(3) U.S. Pat. No. 7,384,164 by Yu, which discloses a liquid dispensing container includes a transparent or translucent vial. A base is secured to the vial and contains a light source and a battery source. The light source being monochromatic or outputting multiple colors in sequence. A switch is provided for selectively forming electrical engagement between the light source and the battery source. A printed circuit board interspersed between the light source and the battery source affords optional subcircuits including a timer, step-up voltage, or step-down voltage capabilities, or light source output color modulation.

(4) U.S. Pat. No. 7,422,339 by Jordan, which discloses a chemiluminescent container system comprises an outer container forming an outer cavity for holding a first fluid and an internal cavity located within the outer cavity for holding a chemiluminescent device. The chemiluminescent device is secured to the outer container within the internal cavity and comprises an outer container for holding a first chemiluminescent material and a frangible inner container which holds a second chemiluminescent material. The chemiluminescent device further comprises an actuator formed on the outer container of the chemiluminescent device in a location accessible to a user for breaking the frangible inner container and admixing the first and second chemiluminescent materials to produce a chemiluminescent effect.

(5) U.S. Pat. No. 7,771,073 by Chen, which discloses a luminous water bottle includes a bottle body, a lid, and a lighting assembly. The bottle body has a bottom wall, and a surrounding wall extending upwardly from a periphery of the bottom wall and cooperating with the bottom wall to define a space. The surrounding wall has an upper end opposite to the bottom wall. The lid is releasably engaged with the upper end of the surrounding wall. The lighting assembly is disposed at least partially in the space and includes a light-generating unit for generating and emitting light, and an illumination member for dispersing the light emitted by the light-generating unit.

(6) U.S. Pat. No. 8,087,809 by Tikhman, which discloses bottle sets are disclosed to highlight a sign in a transparent container. In one embodiment, a bottle set includes a bottle and a base. A fixture is provided and disposed within the bottle. The fixture includes a light guide extended from an interior bottom of the bottle. The bottle is positioned onto the base, where the base provides a light source lighting of which is guided through the light guide to shine the mark on the fixture.

(7) U.S. Pat. No. 8,123,845 by Omatsu, et al., which discloses a dual color ink composition which comprises: (a) at least one pigment selected from a pearlescent pigment and a metal powder pigment; (b) water; (c) at least one water-soluble organic solvent selected from alcohols, glycols and glycol ethers, any of which have a branched hydrophobic group; (d) a water-soluble dye; and (e) a modified starch as a water-soluble fixing agent.

(8) U.S. Pat. No. 8,622,247 by Zuloff, which discloses a light up projection device with a housing and an actuator. The housing has a cavity reservoir for storing a liquid, a front end with an aperture, and a rear end with an opening. The actuator has a handle portion and a plunger portion extending therefrom. The plunger portion encloses the opening of the rear end of the cavity reservoir and interacts with the cavity reservoir to vary the volume of the cavity reservoir. A light source disposed within the actuator illuminates the actuator, the cavity reservoir and/or the liquid being projected from the device. The light source is off when the handle portion abuts the housing. The light source is on when the handle portion is pulled away from the housing, such as when liquid is being drawn into the cavity reservoir or when liquid is being projected from the cavity reservoir through the aperture.

(9) U.S. Pat. Application Publication No. 2004/0218402 by Jao, which discloses an article includes at least one closed chamber made of a transparent plastic material by way of injection molding and supersonic welding for containing at least one type of liquid and/or floating ornament; and an illuminating structure including a plurality of light-conducting bodies fixedly provided in the closed chamber with one end pressed against an inner surface of a wall portion of the closed chamber, and a light-emitting device mounted in a base that is connected to an outer side of the closed chamber corresponding to the light-conducting bodies. The light-emitting device includes a plurality of light-emitting diodes (LEDs) that may be conveniently turned on via a vibration or sound actuated switch to emit light for projecting into the light-conducting bodies via one end thereof and producing luminous spots or surfaces thereon, so as to create a unique decorating effect on the article.

(10) U.S. Pat. Application Publication No. 2004/0246700 by Palmer, which discloses a photoluminescent fluid is caused to emit visible or non-visible electromagnetic energy by being irradiated with an excitation energy source, such as ultraviolet light. The fluid is circulated along or through a pathway to create certain special effects.

(11) U.S. Pat. Application Publication No. 2005/0167445 by Mochiacvili, which discloses an illuminating pouring spout for use and attachment on an open end of a liquid container. The pouring spout bears elastically against the inner wall of the liquid container to hold it in place. The pouring spout contains a power source and a light source in a chamber within the pouring spout. The power source and light source are connected in such a way that when the liquid container is moved, grasped or inverted for pouring the illuminating pouring spout is engaged until it is released or still. The light source may be aimed down into the liquid container and/or aimed outward from the dispensing end of the pouring spout. When engaged, the illuminating pouring spout's-visual effects are pleasing to the eyes of nearby observers and are useful for advertising and attracting business.

One embodiment of the invention is directed towards an apparatus, such as squirt guns, bottles, squeezable and other fluid emitting devices, which are configured to eject an excited photoluminescence composition, e.g., fluid/semisolid, the photoluminescence composition in an excited state provides a glow in the dark emission. In one embodiment, the photoluminescence composition, e.g., fluid/semisolid, is a mixed powder composition that is non-toxic, is non-radioactive, does not stain fabrics, provides visible glow for hours after activation and any combination of the same. Photoluminescence is light emission from any form of matter after the absorption of photons (electromagnetic radiation). As used herein throughout, photoluminescent and photoluminescence may be used interchangeably. In one embodiment, the photoluminescence composition is excited within the apparatuses described herein and then ejected from an aperture of the device. Optionally and/or alternatively, the device may also include a fluid flow generator, such as a mechanical pump, capable of inducing the flow of the fluid through the flow path and a trigger or valve capable of activating said fluid flow generator. In a preferred embodiment, the space within the light transmission device and the outermost region of the composition maintains a distance of about 0.25 inch or less.

In one embodiment, the photoluminescent apparatus is configured as a writing device, e.g., marker. Optionally and/or alternatively, the device may also be a recreational product, such a glow in the dark toy, paint, cosmetic, makeup, ink, and any combination therein.

Another embodiment is directed towards an apparatus for generating and discharging a photoluminescent composition, e.g., a non-toxic, nonradioactive luminescent fluid/semisolid composition that is safe for human contact. In this embodiment, the photoluminescent composition includes a fluid having about 15% to about 50% phosphorescent pigment suspended in a binder or binder/water mix. The photoluminescent pigments are particles, sizing larger than about 40 μm, and include at least one phosphor such as zinc sulfide, alkaline earth aluminate, or Alkaline earth silicate. Additional fluorescent pigments may be added to the photoluminescent pigments to adjust the color. The pigments may be coated with a protective water-proof coat for use in water based mediums. In this embodiment, the particles are stabilized in non-toxic solution, e.g., an aloe vera solution, as a binder and buffering agent. The aloe vera concentration may be 50-85%. Optionally and alternatively, other agents as known in the art may be added as a binder, buffering agent and addition to the one disclosed.

In one embodiment, the photoluminescent composition includes a phosphorescent pigment and a binder. Optionally and alternatively, the composition may also in include water to mix to suspend the particles in a fluid or semifluid. The water may be a binder/water mixture. The binders may include any material to increase or decrease the viscosity of the solution, e.g., binders may include aloe vera, clear plasticizer, liquid latex, polyvinyl material, acrylic resin, clear enamels, acrylic based lacquers, polyurethane, fiberglass and combinations thereof.

In one embodiment, the phosphorescent pigment may include at least one phosphor configured to emit one or more photons upon activation. The pigments may include non-toxic pigments, such as, zinc sulfide, alkaline earth aluminate, alkaline earth silicate and combinations thereof. In a preferred embodiment, the phosphorescent pigment is configured to not degrade in aqueous fluids and may optionally require a water-proof coating. In one embodiment, the pigments have a size in the range from about 20 μm to about 1000 μm or greater. In a preferred embodiment, the size range is from about 40 μm to about 85 μm, in a more preferred embodiment the size range is from about 85 μm to about 100 μm, and in a more preferred embodiment the size range is about 100 μm to about 125 μm. In a preferred embodiment, the pigments may include on more GloTech International pigments, such as, GT8700 and GTB8700, Ready Set Glo glow powders, and GloNation glow powders.

Optionally and alternatively, one may include other components in the composition, e.g., fragrances to add an aroma or more than one color, color pigments to add a color or more than one color, water to dilute the composition depending on the application or fluorescent pigments may be added to adjust the color, combinations and the like.

The concentrations may vary, e.g., the phosphorescent pigment may have a concentration in range from about 15 vol. percent to about 50 vol. percent, the binder may have a concentration in range from about 85 vol. percent to about 50 vol percent or less. In a preferred embodiment, there will be 40 vol. percent phosphorescent pigment and 60 vol. percent binder.

In one embodiment, the binders may include clear enamel, acrylic based lacquers, polyurethane, fiberglass and any combination thereof. Optionally and alternatively, the solution may include a solvent based solution, e.g., paint thinner, acetone and the like. Optionally and alternatively, fluid additivities may be added to affect the viscosity (increase or decrease viscosity), e.g., water may be added to change the viscosity to adapt to different types of emitting devices. The pigment is capable of absorbing and storing energy from ambient light to emit a bright glow for extended periods of time. The particles may be coated to prevent derogation in aqueous solutions.

In one embodiment, an apparatus is configured to hold and activate the photoluminescent composition. The photoluminescent composition is activated if it emits a glow without any external source of energy. The apparatus includes fully or partially translucent surfaces. Optionally and alternatively, the apparatus is configured to emit the photoluminescent composition, e.g., with a mechanical pump, spray trigger pump, pressurized gas through a valve, gravity through an opening, dipping stick or brush, and combinations of the same. Optionally and alternatively, the apparatus contains an electromagnetic radiation device that activates the fluid. The emitting mechanism may contain a light source if the fluid is stored in an extra cavity before emission.

Reference will now be made in detail to an embodiment of the present invention, example of which is illustrated in the accompanying drawings.

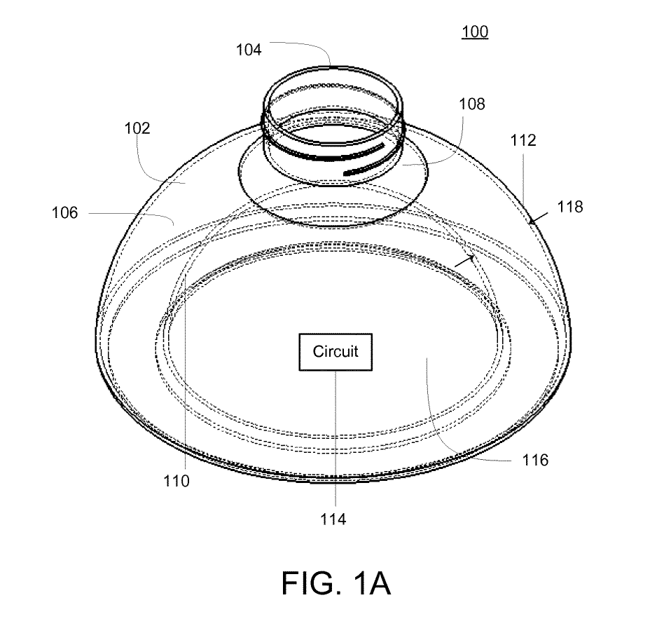

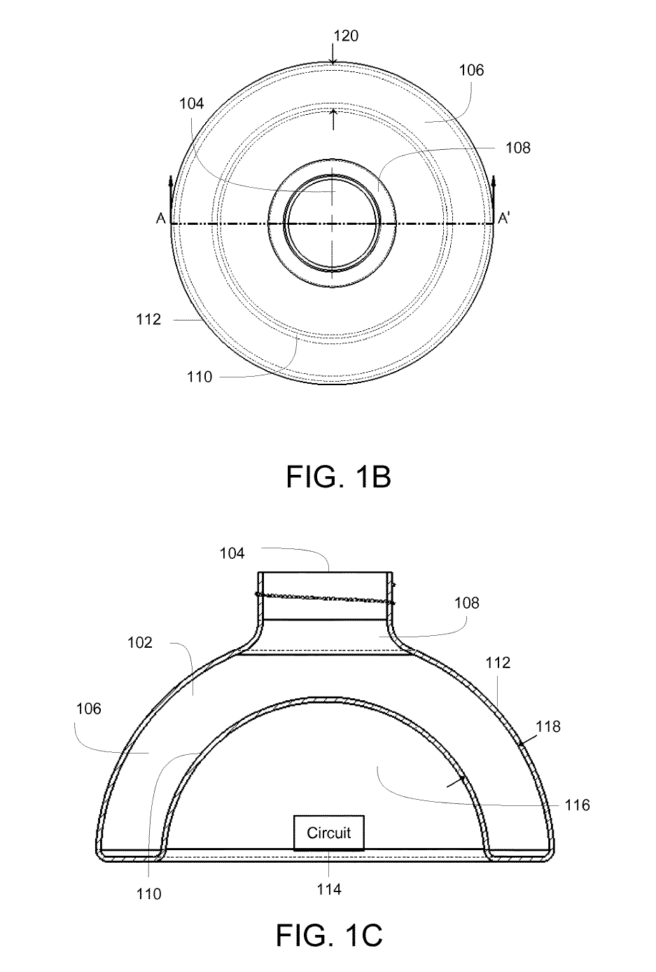

FIG. 1A illustrates an exemplary perspective view of a photoluminescent activator apparatus according to an embodiment of the invention. FIG. 1B illustrates a top view according to FIG. 1A. FIG. 1C illustrates a cross-sectional view of the photoluminescent activator apparatus according to FIG. 1B along line A-A′.

Referring to FIGS. 1A-1C, the apparatus is generally depicted as number 100. The apparatus 100 includes a container 102, a circuit 114, and an aperture 104 at the top of the container configured to receive/expunge a photoluminescent composition out of the chamber 106 of the container 102. The container 102 includes an outer container wall 112 and inner container wall 110. A chamber 106 between the outer container wall 112 and inner container wall 110 is configured to be in fluid communication with the aperture 104 and receive the photoluminescent composition. The aperture 104, on the containers neck 108, may have a mechanism for attaching a fluid emitting device (not shown) to the container 102. The mechanism may be threads, snap lock, tongue and groove system, compressive fit system and combinations of the same. In this embodiment, threads are used as the mechanism. The fluid emitting device may be a mechanical pump, spray bottle head, squeezing head, and combinations of the same that are capable of providing the photoluminescent composition from the chamber 106 through the device aperture 104. In a preferred embodiment, the fluid emitting device is configured to emit the photoluminescent composition in a spray, stream or mist form external to the apparatus 100. The chamber 106 is where the photoluminescent composition is held and also where the photoluminescent composition is activated. Activated means providing the photoluminescent composition with energy required to energize the composition so that photoluminescent composition will produce light. The length of time the photoluminescent composition will produce light is known as persistence of the photoluminescent composition as described herein throughout.

A circuit 114 configured to emit energy, e.g., light, and resides in a portion of the apparatus 100. The light is configured to radiate an inner wall of the container and activate the photoluminescent composition in the chamber 106. In a preferred embodiment, the light source includes one or more light source(s). Examples of an light source is a light emitting diode (LED), halogen lamp, laser, xenon, fluorescent lamp, chemiluminescence device, the like and combinations thereof. In a preferred embodiment, the light source emits light in the ultraviolet wavelength, which is configured to activate the photoluminescent composition. Optionally and alternatively, the light source may be configured to emit light a specified wavelength or range of wavelengths.

In a preferred embodiment, the inner wall 110 includes an energy transparent material configured to allow energy, e.g., light to penetrate or pass through the material and into the photoluminescent composition in the chamber 106 with little or no resistance. The transparent material may include glass, acrylic, polycarbonate, styrene and combinations of the same. In a preferred embodiment the outer wall 112 is made of, coated, or wrapped with reflective materials configure to the light back into the chamber 106 with minimal or no energy loss. In one embodiment, the reflective coating includes one or more chrome, aluminum, silver, gold, platinum, nickel, inconel, and combinations of the same. In a preferred embodiment, the coating is applied to one or more of an inner surface of the outer wall 112 and an outer surface of the outer wall 112.

A space 116 is located between the light source (not shown), which is part of the circuit 114, and an inner wall 110. In this embodiment, the space 116 is filled with an air medium. Optionally and alternatively, the space 116 may be a vacuum space, partially filled or filled with other mediums, e.g., gases, transparent fluids, semisolids or solids such as water, hydrogel, glycerol, glass, acrylic, polycarbonate, styrene, combinations of the same and the like. The gases may be configured to be activated with light, e.g., neon, hydrogen, helium, carbon dioxide, mercury. The gases may be an inert gas. In one embodiment, the space is filed with a transparent media to minimize any light loss between the light source and the inner wall 110. The photoluminescent composition is described herein. Depending on the properties of the photoluminescent composition in the chamber 106, the light may not be able to penetrate completely through the photoluminescent composition.

In a preferred embodiment, the chamber 106 is shaped by the inner wall 110 and the outer wall 112 such the photoluminescent compositions contained within the chamber receives the maximum amount of energy from the light source of the circuit 114. This energy is described as activation energy. In a one embodiment, the distance between the inner wall 110 and outer wall 112 is a range from about 0.01 inch to about 20 inches. In this embodiment, the shortest distance 118 is about 0.01 to about 1 inch. In a preferred embodiment, the distance is in a range from about 0.1-0.25 inch.

In one embodiment, the inner wall 110 and outer wall 112 are configured to form a chamber such that about 0.01% percent of the volume of the composition is activated with the energy from the light substantially simultaneously, in a preferred embodiment, more than 10% of the percent of the volume of the photoluminescent composition is activated with the energy from the light substantially simultaneously, in a more preferred embodiment, more than 25% of the percent of the volume of the photoluminescent composition is activated with the energy from the light substantially simultaneously, in a more preferred embodiment, more than 50% of the percent of the volume of the photoluminescent composition is activated with the energy from the light substantially simultaneously, in a more preferred embodiment, more than about 75% of the percent of the volume of the photoluminescent composition is activated with the energy from the light substantially simultaneously, and in a more preferred embodiment, about 100% of the percent of the volume of the photoluminescent composition is activated with the energy from the light substantially simultaneously.

In a preferred embodiment, the photoluminescent composition includes about 20% phosphorescent particles, about 40% binder, e.g., aloe vera, and about 40% water. The composition has a viscosity to prevent the particles from settling and still allow it to be emitted with a fluid emitting device (not shown).

Optionally and/or alternatively, the colloidal suspension of the particles may have a mixing method to prevent settling before emitting at ambient temperatures and/or above; this could be mechanical as a ball or air bubble that would disturb the fluid when the bottle is shaken. The mixer may be electromechanical or adapted in the emitting fluid path.

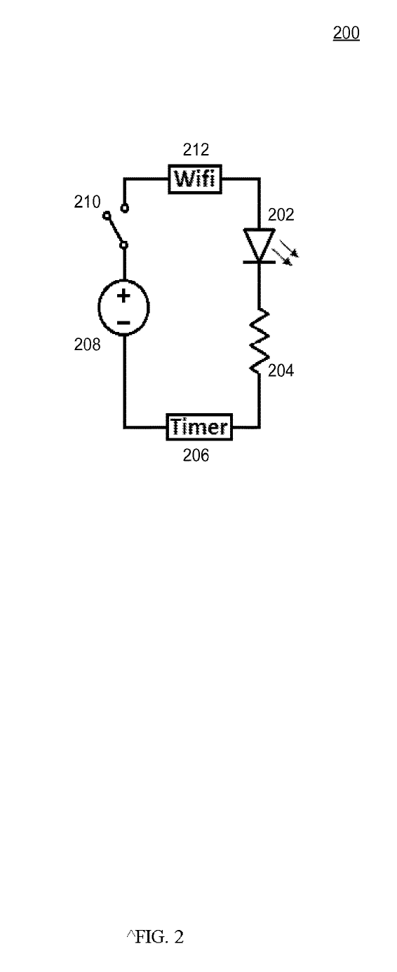

FIG. 2 illustrates an exemplary light source circuit according to an embodiment of the invention.

Referring to FIG. 2, the circuit is generally depicted with reference to number 200. The circuit 200 includes light source 202, e.g., LED, a resistor 204, a power source 206, optionally a timer circuit or timer 208, a switch 210, optionally a network interface 212, e.g., wife, Bluetooth, and the like. These various components are electrically coupled to each other. Of course, more than one light source 202 may be added to the circuit in series or in a parallel configuration. The power source may be one or more AC power, DC power, solar power, and battery power.

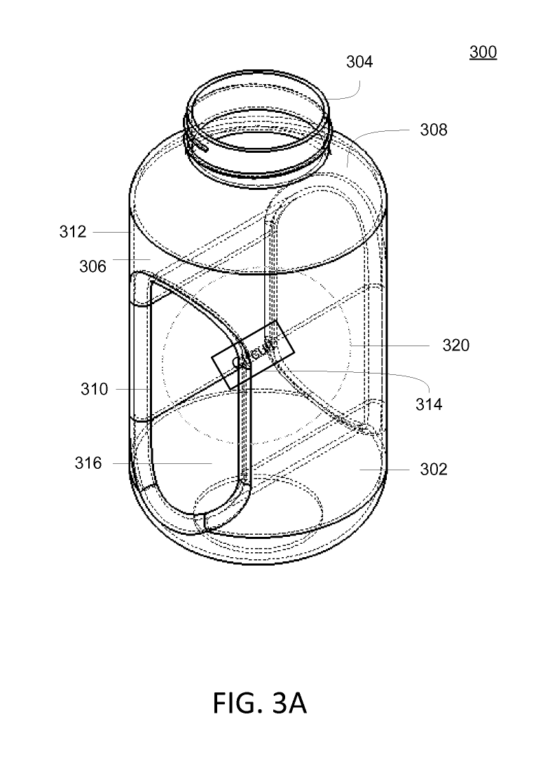

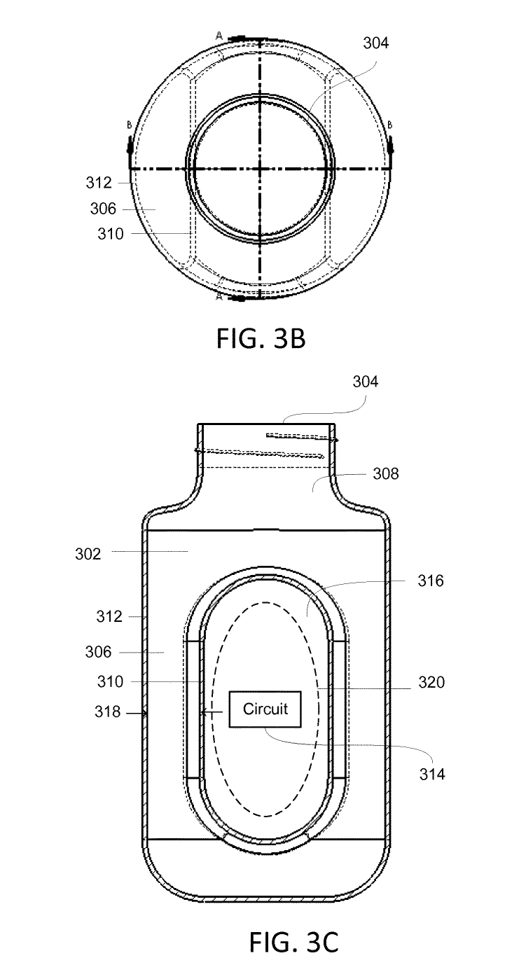

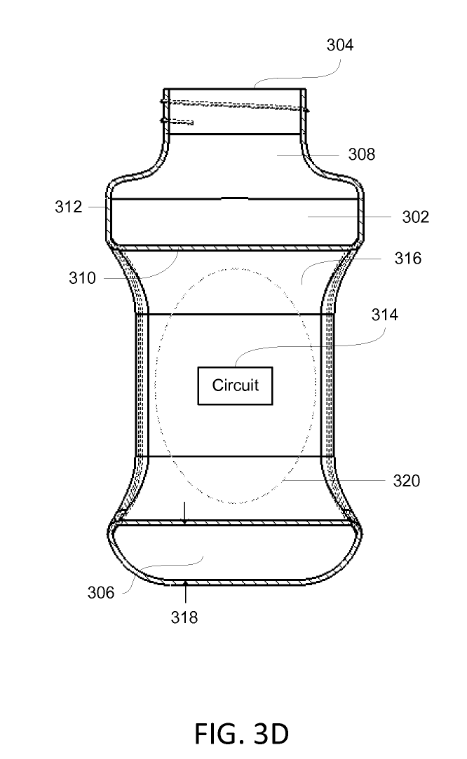

FIG. 3A illustrates an exemplary perspective view of a photoluminescent activator apparatus according to another embodiment of the invention. FIG. 3B illustrates a top view of the photoluminescent activator apparatus according to FIG. 3A. FIG. 3C illustrates a cross sectional view of the photoluminescent activator apparatus according to FIG. 2B along the line B-B′. FIG. 3D illustrates a cross sectional view of the photoluminescent activator apparatus according to FIG. 2B along the line A-A′

Referring to FIGS. 3A-3D, the apparatus is generally depicted as number 300. The apparatus 300 includes a container 302, a circuit 314, and an aperture 304 at the top of the container configured to receive/expunge a photoluminescent composition out of the chamber 306 of the container 302. The container 302 includes an outer container wall 312 and inner container wall 310. A chamber 306 between the outer container wall 312 and inner container wall 310 is configured to be in fluid communication with the aperture 304 and receive the photoluminescent composition. The aperture 304, on the container neck 308, may have a mechanism for attaching a fluid emitting device (not shown) to the container 302. The mechanism may be threads, snap lock, tongue and groove system, compressive fit system and combinations of the same. The fluid emitting device may be a mechanical pump, spray bottle head, squeezing head, and combinations of the same that are capable of providing the photoluminescent composition from the chamber 306 through the device aperture 304. In a preferred embodiment, the fluid emitting device is configured to emit the photoluminescent composition in a spray, stream or mist form external to the apparatus 300. The chamber 306 is where the photoluminescent composition is held and also where the photoluminescent composition is activated. Activated means providing the photoluminescent composition with energy required to energize the composition so that photoluminescent composition will produce light. The length of time the photoluminescent composition will produce light is known as persistence of the photoluminescent composition as described herein throughout.

A circuit 314 configured to emit energy, e.g., light, and resides in a portion of the apparatus 300. The light is configured to radiate an inner wall of the container and activate the photoluminescent composition in the chamber 306. The emitted energy will be spread between the inner wall 310 volume 320. In a preferred embodiment, the light source includes one or more light source(s). Examples of an light source is a light emitting diode (LED), halogen lamp, xenon, fluorescent lamp, chemiluminescence device, etc. In a preferred embodiment, the light source emits ultraviolet light, which is configured to activate the photoluminescent composition.

In a preferred embodiment, the inner wall 310 includes an energy transparent material configured to allow energy, e.g., light to penetrate or pass through the material and into the photoluminescent composition in the chamber 306 with little or no resistance. The transparent material may include glass, acrylic, polycarbonate, styrene and combinations of the same. In a preferred embodiment the outer wall 312 is made of, coated, or wrapped with reflective materials configure to the light back into the chamber 306 with minimal or no energy loss. In one embodiment, the reflective coating includes one or more chrome, aluminum, silver, gold, platinum, nickel, inconel, and combinations of the same. In a preferred embodiment, the coating is applied to one or more of an inner surface of the outer wall 312 and an outer surface of the outer wall 312.

A space 316 is located between the light (not shown), which is part of the circuit 314, and an inner wall 310. In this embodiment, the space 316 is filled with an air medium. Alternatively and/or optionally, the space 316 may be a vacuum space, partially filled or filled with other mediums, e.g., gases, transparent fluids, semisolids or solids such as water, hydrogel, glycerol, glass, acrylic, polycarbonate, styrene, combinations of the same and the like. The gases may be configured to be activated with light, e.g., neon, hydrogen, helium, carbon dioxide, mercury. The gases may be an inert gas. In one embodiment, the space is filed with a transparent media to minimize any light loss between the light source and the inner wall 310. The photoluminescent composition is described herein. Depending on the properties of the photoluminescent composition in the chamber 306, the light may not be able to penetrate completely through the photoluminescent composition.

In a preferred embodiment, the chamber 306 is shaped by the inner wall 310 and the outer wall 312 such the photoluminescent compositions contained within the chamber receives the maximum amount of energy from the light source of the circuit 314. This energy is described as activation energy. In a one embodiment, the distance between the inner wall 310 and outer wall 312 is a range from about 0.01 inch to about 20 inches. In this embodiment, the shortest distance 318 is about 0.01 to about 1 inch. In a preferred embodiment, the distance is in a range from about 0.1-0.25 inch.

In one embodiment, the inner wall 310 and outer wall 312 are configured to form a chamber such that about 0.01% percent of the volume of the composition is activated with the energy from the light substantially simultaneously, in a preferred embodiment, more than 10% of the percent of the volume of the photoluminescent composition is activated with the energy from the light substantially simultaneously, in a more preferred embodiment, more than 25% of the percent of the volume of the photoluminescent composition is activated with the energy from the light substantially simultaneously, in a more preferred embodiment, more than 50% of the percent of the volume of the photoluminescent composition is activated with the energy from the light substantially simultaneously, in a more preferred embodiment, more than about 75% of the percent of the volume of the photoluminescent composition is activated with the energy from the light substantially simultaneously, and in a more preferred embodiment, about 100% of the percent of the volume of the photoluminescent composition is activated with the energy from the light substantially simultaneously.

In a preferred embodiment, the photoluminescent composition includes about 20% phosphorescent particles, about 40% binder, e.g., aloe vera, and about 40% water. The composition has a viscosity to prevent the particles from settling and still allow it to be emitted with a fluid emitting device (not shown).

Optionally and/or alternatively, the colloidal suspension of the particles may have a mixing method to prevent settling before emitting at ambient temperatures and/or above; this could be mechanical as a ball or air bubble that would disturb the fluid when the bottle is shaken. The mixer may be electromechanical or adapted in the emitting fluid path.

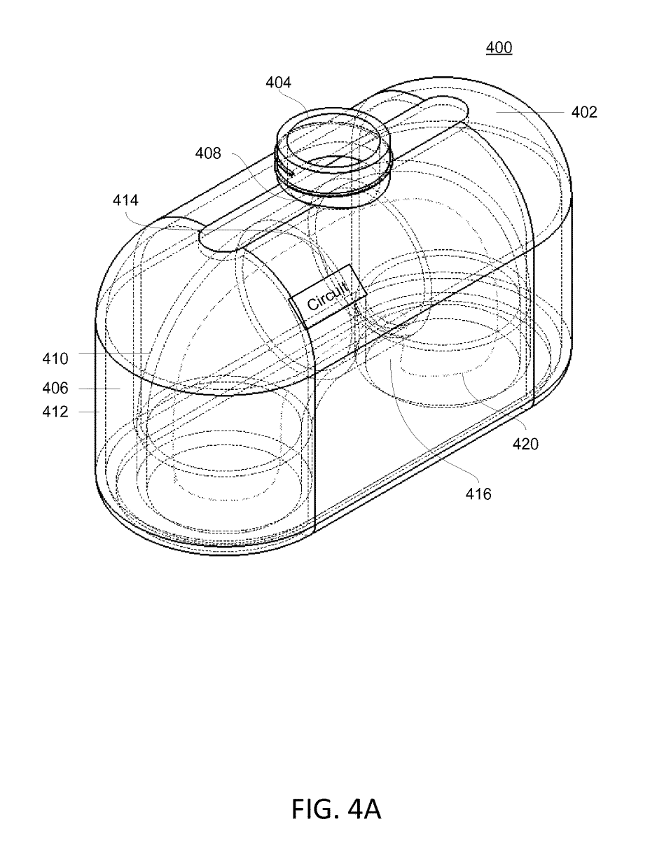

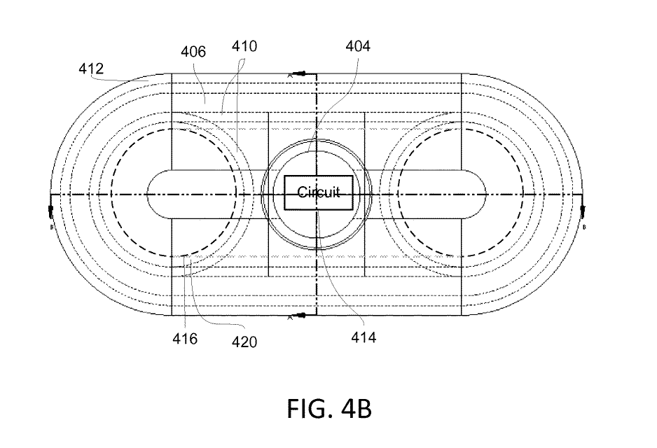

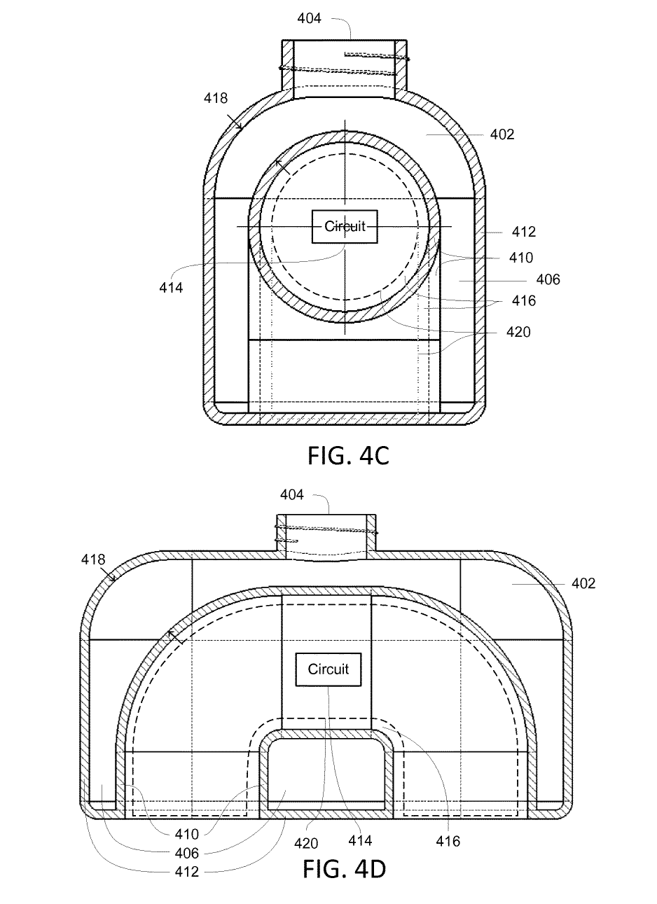

FIG. 4A illustrates an exemplary perspective view of a photoluminescent activator apparatus according to another embodiment of the invention. FIG. 4B illustrates a top view of the photoluminescent activator apparatus according to FIG. 4A. FIG. 4C and FIG. 4D illustrates a cross sectional view of the photoluminescent activator apparatus according to FIG. 4B along the line A-A′ and B-B′, respectively.

Referring to FIGS. 4A-4D, the apparatus is generally depicted as number 400. The apparatus 400 includes a container 402, a circuit 414, and an aperture 404 at the top of the container configured to receive/expunge a photoluminescent composition out of the chamber 406 of the container 402. The container 402 includes an outer container wall 412 and tube that enters from one part of the peripheral wall and exits another part of the peripheral wall; the walls of this tube are illustrated as 410. A chamber 406 between the outer container wall 412 and inner tube wall 410 is configured to be in fluid communication with the aperture 404 and receive the photoluminescent composition. The aperture 404, on the container neck 408, may have a mechanism for attaching a fluid emitting device (not shown) to the container 402. The mechanism may be threads, snap lock, tongue and groove system, compressive fit system and combinations of the same. The fluid emitting device may be a mechanical pump, spray bottle head, squeezing head, and combinations of the same that are capable of flowing the photoluminescent composition from the chamber 406 through the device aperture 404. In a preferred embodiment, the fluid emitting device is configured to emit the photoluminescent composition in a spray, stream or mist form external to the apparatus 400. The chamber 406 is where the photoluminescent composition is held and also where the photoluminescent composition is activated. Activated means providing the photoluminescent composition with energy required to energize the composition so that photoluminescent composition will produce light. The length of time the photoluminescent composition will produce light is known as persistence of the photoluminescent composition as described herein throughout.

A circuit 414 configured to emit energy, e.g., light, and resides in a portion of the apparatus 400. The light is configured to radiate towards the inner tube wall 410 of the container and activate the photoluminescent composition in the chamber 406. The emitted energy will be spread between the inner tube volume 420. In a preferred embodiment, the light source includes one or more light source(s). Examples of a light source is a light emitting diode (LED), halogen lamp, xenon, fluorescent lamp, chemiluminescence device, etc. In a preferred embodiment, the light source emits ultraviolet light, which is configured to activate the photoluminescent composition.

In a preferred embodiment, the inner tube wall 410 includes an energy transparent material configured to allow energy, e.g., light to penetrate or pass through the material and into the photoluminescent composition in the chamber 406 with little or no resistance. The transparent material may include glass, acrylic, polycarbonate, styrene and combinations of the same. In a preferred embodiment the outer wall 412 is made of, coated, or wrapped with reflective materials configure to the light back into the chamber 406 with minimal or no energy loss. In one embodiment, the reflective coating includes one or more chrome, aluminum, silver, gold, platinum, nickel, inconel, and combinations of the same. In a preferred embodiment, the coating is applied to one or more of an inner surface of the outer wall 412 and an outer surface of the outer wall 412.

A space 416 is located between the light (not shown), which is part of the circuit 414, and an inner tube wall 410. In this embodiment, the space 416 is filled with an air medium. Alternatively and/or optionally, the space 416 may be a vacuum space, partially filled or filled with other mediums, e.g., gases, transparent fluids, semisolids or solids such as water, hydrogel, glycerol, glass, acrylic, polycarbonate, styrene, combinations of the same and the like. The gases may be configured to be activated with light, e.g., neon, hydrogen, helium, carbon dioxide, mercury. The gases may be an inert gas. In one embodiment, the space is filed with a transparent media to minimize any light loss between the light source and the inner wall 410. The photoluminescent composition is described herein. Depending on the properties of the photoluminescent composition in the chamber 406, the light may not be able to penetrate completely through the photoluminescent composition.

In a preferred embodiment, the chamber 406 is shaped by the inner tube wall 410 and the outer wall 412 such the photoluminescent compositions contained within the chamber receives the maximum amount of energy from the light source of the circuit 414. This energy is described as activation energy. In one embodiment, the distance between the inner tube wall 410 and outer wall 412 is a range from about 0.01 inch to about 20 inches. In this embodiment, the shortest distance 418 is about 0.01 to about 1 inch. In a preferred embodiment, the distance is in a range from about 0.1-0.25 inch.

In one embodiment, the inner tube wall 410 and outer wall 412 are configured to form a chamber such that about 0.01% percent of the volume of the composition is activated with the energy from the light substantially simultaneously, in a preferred embodiment, more than 10% of the percent of the volume of the photoluminescent composition is activated with the energy from the light substantially simultaneously, in a more preferred embodiment, more than 25% of the percent of the volume of the photoluminescent composition is activated with the energy from the light substantially simultaneously, in a more preferred embodiment, more than 50% of the percent of the volume of the photoluminescent composition is activated with the energy from the light substantially simultaneously, in a more preferred embodiment, more than about 75% of the percent of the volume of the photoluminescent composition is activated with the energy from the light substantially simultaneously, and in a more preferred embodiment, about 100% of the percent of the volume of the photoluminescent composition is activated with the energy from the light substantially simultaneously.

In a preferred embodiment, the photoluminescent composition includes about 20% phosphorescent particles, about 40% binder, e.g., aloe vera, and about 40% water. The composition has a viscosity to prevent the particles from settling and still allow it to be emitted with a fluid emitting device (not shown).

Optionally and/or alternatively, the colloidal suspension of the particles may have a mixing method to prevent settling before emitting at ambient temperatures and/or above; this could be mechanical as a ball or air bubble that would disturb the fluid when the bottle is shaken. The mixer may be electromechanical or adapted in the emitting fluid path.

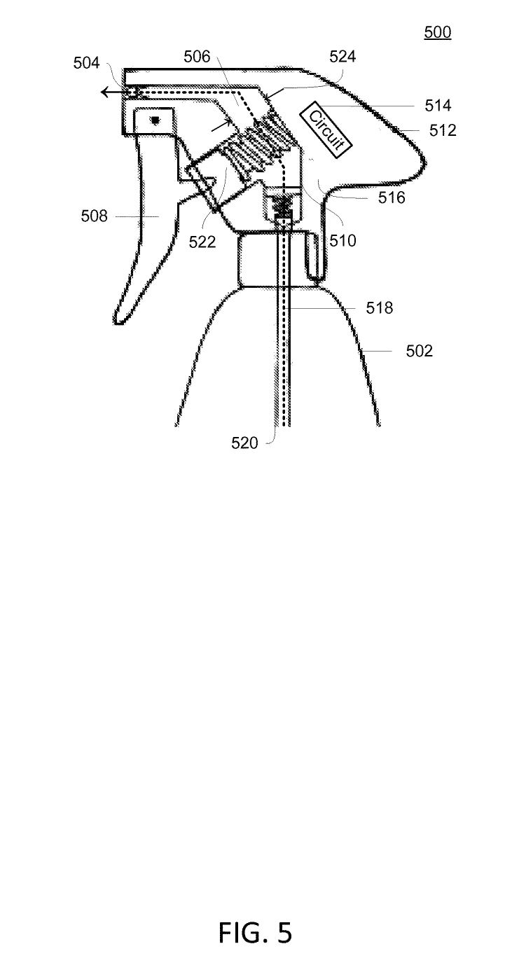

FIG. 5 illustrates an exemplary side view of a fluid emitting device according to another embodiment of the invention.

Referring to FIG. 5, the apparatus is generally depicted as number 500. The apparatus 500 includes a mounting container 502, a fluid path 518, a flow generator 522, a mechanism for initiating flow 508, and a circuit 514. In a preferred embodiment, the mechanism is configured to emit the photoluminescent composition in a spray, stream or mist form external to the container 502, through the fluid path 518. The emitting apparatus includes an outer wall 512 and chamber wall 510. The fluid path 518 receives the photoluminescent composition out of the container 502 through the fluid inlet 520, and expunges a photoluminescent composition out of the fluid outlet 504. A chamber 506 within the fluid path is configured to be in contact with the flow generator 522. The flow generator 522 moves the fluid through the fluid path 518. In one embodiment, the flow generator 522 includes one or more mechanical or electrical pump, e.g. piston pump and peristatic pump. The mechanism for initiating flow 508 is in communication with the flow generator 522 to initiate fluid flow through the fluid path 518. The mechanism for initiating flow 508 could be manual user operated like a trigger, electrical, or combinations of the same. The chamber 506 is where a surplus of the photoluminescent composition is held and also where the photoluminescent composition within the emitter is activated. Activated device providing the photoluminescent composition with energy required to energize the composition so that photoluminescent composition will produce light. The length of time the photoluminescent composition will produce light is known as persistence of the photoluminescent composition as described herein throughout.

In a preferred embodiment, a surplus of the photoluminescent composition is held within the fluid path. Within the chamber walls 510 and the outer emitter walls 512, a circuit 514 is configured to emit energy, e.g. light. The light is configured to radiate at the chamber wall 510 and activate the photoluminescent composition in the chamber 506. In a preferred embodiment, the light source includes one or more light source(s). Examples of an light source is a light emitting diode (LED), halogen lamp, xenon, fluorescent lamp, chemiluminescence device, combinations thereof the like. In a preferred embodiment, the light source emits ultraviolet light, which is configured to activate the photoluminescent composition.

In a preferred embodiment, the chamber wall 510 includes an energy transparent material configured to allow energy, e.g., light to penetrate or pass through the material and into the photoluminescent composition in the chamber 506 with little or no resistance. The transparent material may include glass, acrylic, polycarbonate, styrene and combinations of the same. In a preferred embodiment the outer wall 512 is made of, coated, or wrapped with reflective materials configure to the light back into the chamber 506 with minimal or no energy loss. In one embodiment, the reflective coating includes one or more chrome, aluminum, silver, gold, platinum, nickel, inconel, and combinations of the same. In a preferred embodiment, the coating is applied to one or more of an inner surface of the outer wall 512 and an outer surface of the outer wall 512.

A space 516 is located between the light (not shown), which is part of the circuit 514, and a chamber wall 510. In this embodiment, the space 516 is filled with an air medium. Alternatively and/or optionally, the space 516 may be a vacuum space, partially filled or filled with other mediums, e.g., gases, transparent fluids, semisolids or solids such as water, hydrogel, glycerol, glass, acrylic, polycarbonate, styrene, combinations of the same and the like. The gases may be configured to be activated with light, e.g., neon, hydrogen, helium, carbon dioxide, mercury. The gases may be an inert gas. In one embodiment, the space is filed with a transparent media to minimize any light loss between the light source and the chamber wall 510. The photoluminescent composition is described herein. Depending on the properties of the photoluminescent composition in the chamber 506, the light may not be able to penetrate completely through the photoluminescent composition.

In a preferred embodiment, the chamber 506 is shaped by the chamber wall 510. The photoluminescent compositions contained within the chamber receives the maximum amount of energy from the light source of the circuit 514. This energy is described as activation energy. In a one embodiment, the distance 524 between the chamber wall 510 range from about 0.01 inch to about 1 inch. In a preferred embodiment, the distance is in a range from about 0.1-0.25 inch.

In one embodiment, the chamber 506 is configured such that about 0.01% percent of the volume of the composition is activated with the energy from the light substantially simultaneously, in a preferred embodiment, more than 10% of the percent of the volume of the photoluminescent composition is activated with the energy from the light substantially simultaneously, in a more preferred embodiment, more than 25% of the percent of the volume of the photoluminescent composition is activated with the energy from the light substantially simultaneously, in a more preferred embodiment, more than 50% of the percent of the volume of the photoluminescent composition is activated with the energy from the light substantially simultaneously, in a more preferred embodiment, more than about 75% of the percent of the volume of the photoluminescent composition is activated with the energy from the light substantially simultaneously, and in a more preferred embodiment, about 100% of the percent of the volume of the photoluminescent composition is activated with the energy from the light substantially simultaneously. Optionally and/or alternatively, a photoluminescent activator apparatus as described herein may be used as the container 502.

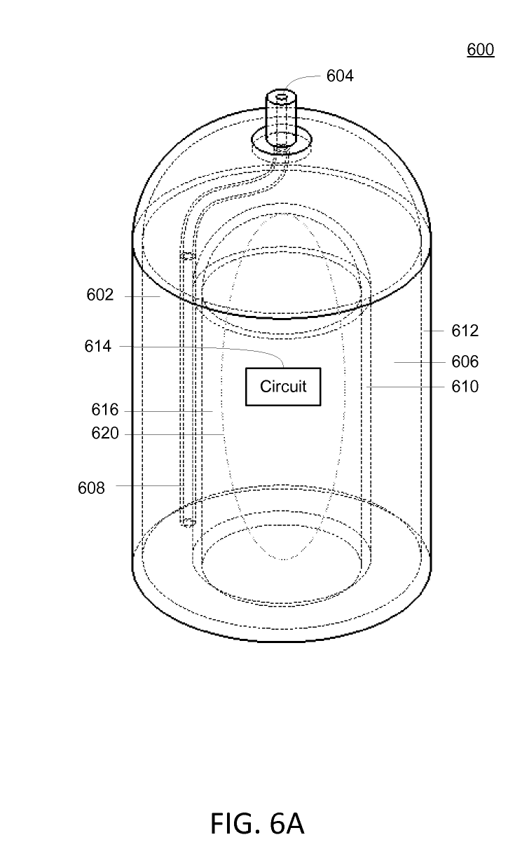

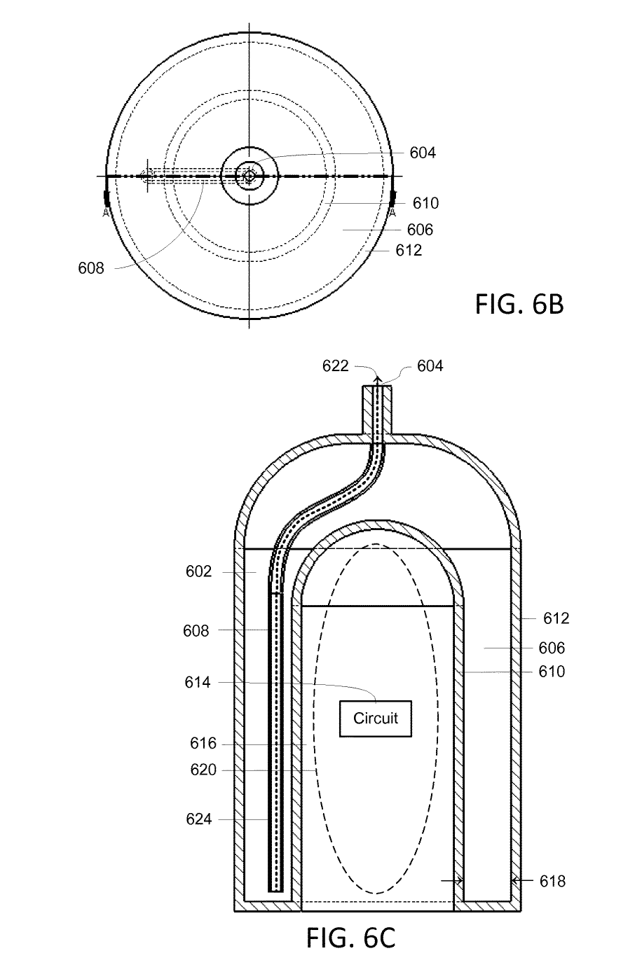

FIG. 6A illustrates an exemplary perspective view of a photoluminescent activator apparatus according to another embodiment of the invention. FIG. 6B illustrates a top view of the photoluminescent activator apparatus according to FIG. 6A. FIG. 6C illustrates a cross sectional view of the photoluminescent activator apparatus according to FIG. 6B along line A-A′.

Referring to FIGS. 6A-6C, the apparatus is generally depicted as number 600. The apparatus 600 includes a container 602, a fluid path 622, a circuit 614, and an aperture 604 at the top of the container configured to receive/expunge a photoluminescent composition out of the chamber 606 of the container 602. The container 602 includes an outer container wall 612 and inner container wall 610. A chamber 606 between the outer container wall 612 and inner container wall 610 is configured to be in fluid communication with the aperture 604 and receive the photoluminescent composition through the fluid path 622. The container 602 is pressurized and attached to the aperture 604 is a valve or a nozzle (not shown). In this embodiment, the photoluminescent composition is stored with a propellant/solvent, similar to an aerosol can as known in the art. Once the valve or nozzle is opened, the higher pressure within bottle will request the photoluminescent composition to flow along the flow path 622, from the bottom of the chamber 606, through a straw 624, then the aperture 604. In a preferred embodiment, the mechanism is configured to emit the photoluminescent composition in a spray, stream or mist form external to the apparatus 600. The chamber 606 is where the photoluminescent composition is held and also where the photoluminescent composition is activated. Activated means providing the photoluminescent composition with energy required to energize the composition so that photoluminescent composition will produce light. The length of time the photoluminescent composition will produce light is known as persistence of the photoluminescent composition as described herein throughout.

A circuit 614 configured to emit energy, e.g., light, and resides in a portion of the apparatus 600. The light is configured to radiate an inner wall of the container and activate the photoluminescent composition in the chamber 606. The emitted energy will be spread between the inner wall volume 620. In a preferred embodiment, the light source includes one or more light source(s). Examples of an light source is a light emitting diode (LED), halogen lamp, xenon, fluorescent lamp, chemiluminescence device, etc. In a preferred embodiment, the light source emits ultraviolet light, which is configured to activate the photoluminescent composition.

In a preferred embodiment, the inner wall 610 includes an energy transparent material configured to allow energy, e.g., light to penetrate or pass through the material and into the photoluminescent composition in the chamber 606 with little or no resistance. The transparent material may include glass, acrylic, polycarbonate, styrene and combinations of the same. In a preferred embodiment the outer wall 612 is made of, coated, or wrapped with reflective materials configure to the light back into the chamber 606 with minimal or no energy loss. In one embodiment, the reflective coating includes one or more chrome, aluminum, silver, gold, platinum, nickel, inconel, and combinations of the same. In a preferred embodiment, the coating is applied to one or more of an inner surface of the outer wall 612 and an outer surface of the outer wall 612.

A space 616 is located between the light (not shown), which is part of the circuit 614, and an inner wall 610. In this embodiment, the space 616 is filled with an air medium. Alternatively and/or optionally, the space 616 may be a vacuum space, partially filled or filled with other mediums, e.g., gases, transparent fluids, semisolids or solids such as water, hydrogel, glycerol, glass, acrylic, polycarbonate, styrene, combinations of the same and the like. The gases may be configured to be activated with light, e.g., neon, hydrogen, helium, carbon dioxide, mercury. The gases may be an inert gas. In one embodiment, the space is filed with a transparent media to minimize any light loss between the light source and the inner wall 610. The photoluminescent composition is described herein. Depending on the properties of the photoluminescent composition in the chamber 606, the light may not be able to penetrate completely through the photoluminescent composition.

In a preferred embodiment, the chamber 606 is shaped by the inner wall 610 and the outer wall 612 such the photoluminescent compositions contained within the chamber receives the maximum amount of energy from the light source of the circuit 614. This energy is described as activation energy. In a one embodiment, the distance between the inner wall 610 and outer wall 612 is a range from about 0.01 inch to about 20 inches. In this embodiment, the shortest distance 618 is about 0.01 to about 1 inch. In a preferred embodiment, the distance is in a range from about 0.1-0.25 inch.

In one embodiment, the inner wall 610 and outer wall 612 are configured to form a chamber such that about 0.01% percent of the volume of the composition is activated with the energy from the light substantially simultaneously, in a preferred embodiment, more than 10% of the percent of the volume of the photoluminescent composition is activated with the energy from the light substantially simultaneously, in a more preferred embodiment, more than 25% of the percent of the volume of the photoluminescent composition is activated with the energy from the light substantially simultaneously, in a more preferred embodiment, more than 50% of the percent of the volume of the photoluminescent composition is activated with the energy from the light substantially simultaneously, in a more preferred embodiment, more than about 75% of the percent of the volume of the photoluminescent composition is activated with the energy from the light substantially simultaneously, and in a more preferred embodiment, about 100% of the percent of the volume of the photoluminescent composition is activated with the energy from the light substantially simultaneously.

In a preferred embodiment, the photoluminescent composition includes about 20% phosphorescent particles, about 40% binder, e.g., aloe vera, and about 40% water. The composition has a viscosity to prevent the particles from settling and still allow it to be emitted with a fluid emitting device (not shown).

Optionally and/or alternatively, the colloidal suspension of the particles may have a mixing method to prevent settling before emitting at ambient temperatures and/or above; this could be mechanical as a ball or air bubble that would disturb the fluid when the bottle is shaken. The mixer may be electromechanical or adapted in the emitting fluid path.

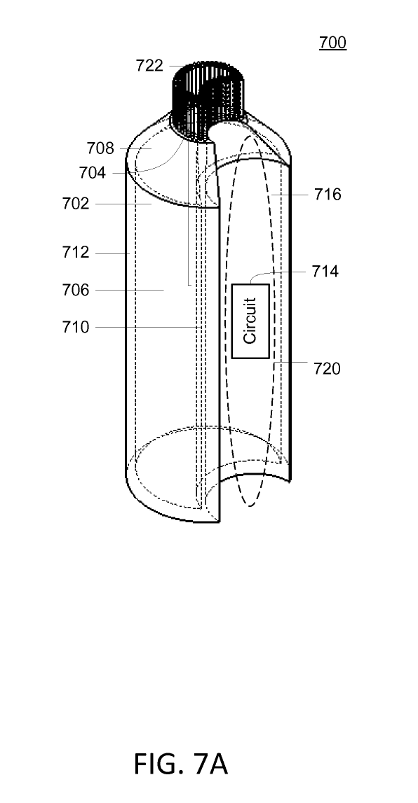

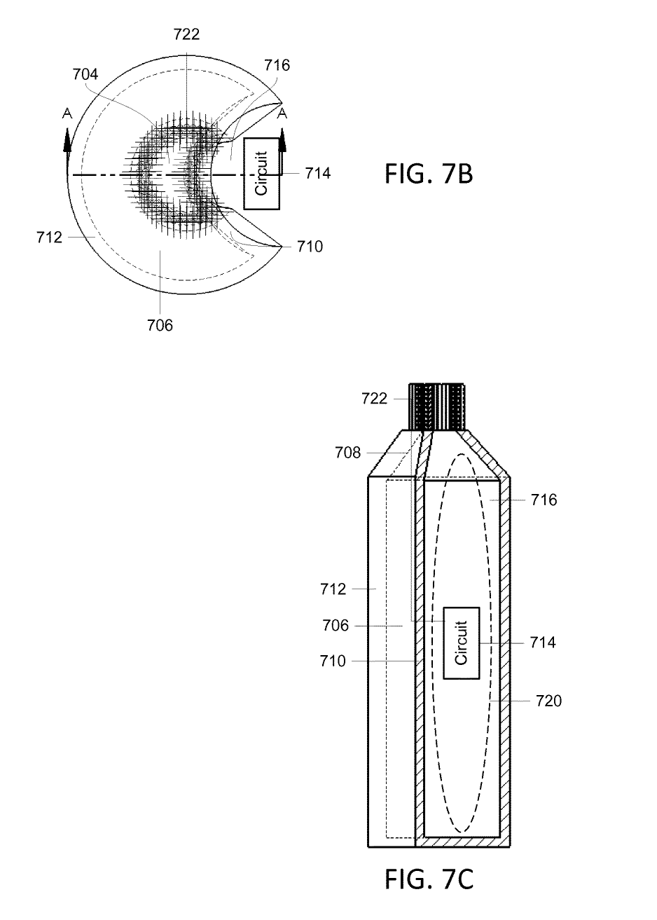

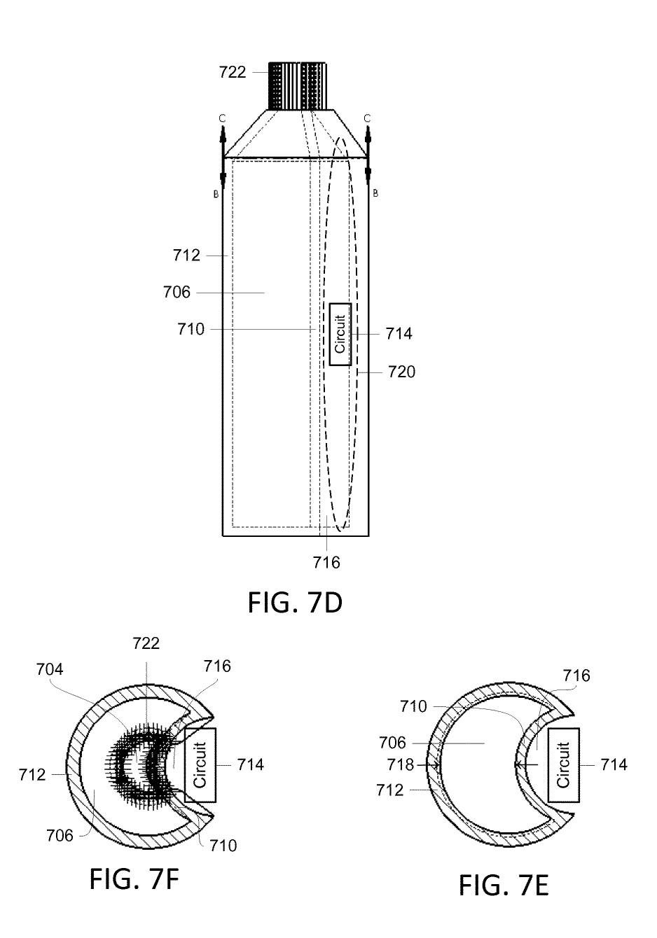

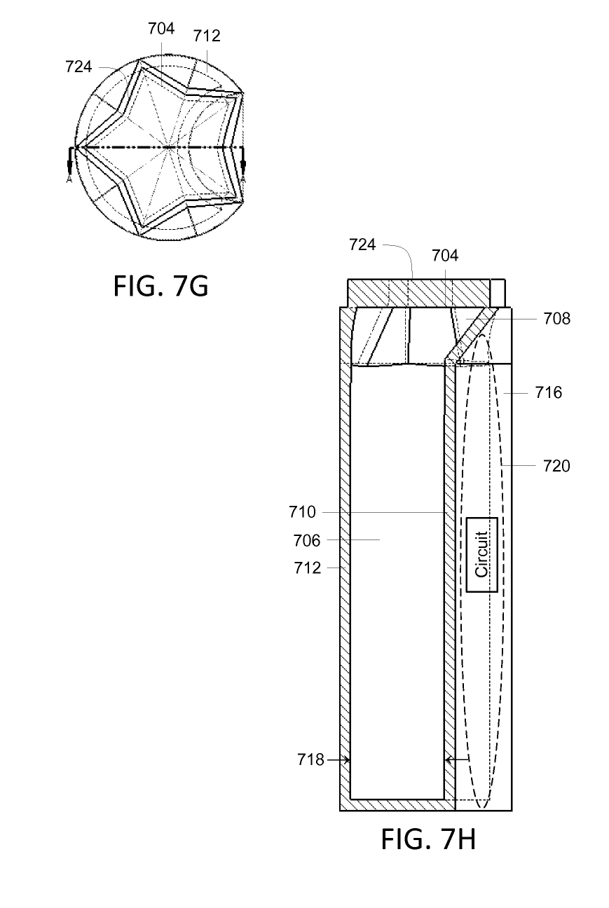

FIG. 7A illustrates an exemplary perspective view of a photoluminescent activator apparatus according to another embodiment of the invention. FIG. 7B illustrates a top view of the photoluminescent activator apparatus according to FIG. 7A. FIG. 7C illustrates a cross sectional view of the photoluminescent activator apparatus according to FIG. 7B along line A-A′. FIG. 7D illustrates a side view of the photoluminescent activator apparatus according to FIG. 7A. FIG. 7E and FIG. 7F illustrates a cross sectional view of the photoluminescent activator apparatus according to FIG. 7D along line C-C′ and B-B′, respectively. FIG. 7G illustrates a top view of the photoluminescent activator apparatus according to FIG. 7A with another aperture head. FIG. 7H illustrates a cross sectional view of the photoluminescent activator apparatus according to FIG. 7G along line A-A′.

Referring to FIGS. 7A-7H, these views show a cut away view illustrates only about 270 degrees of the apparatus for convenience. That is, the apparatus includes a full 360 degrees not shown. The apparatus is generally depicted as number 700. The apparatus 700 is configured as a writing instrument and/or marking instrument with an aperture head 722 or 724. The apparatus includes a container 702, a circuit 714, an aperture 704, and an aperture head 722 or 724 at the top of the container configured to emit a photoluminescent composition out of the chamber 706 of the container 702 on a desired substrate. The container 702 includes an outer container wall 712 and inner container wall 710. A chamber 706 between the outer container wall 712 and inner container wall 710 is configured to be in fluid communication with the aperture 704 and receive the photoluminescent composition. The aperture 704, on the container neck 708, may have a mechanism for attaching an aperture head, 722 in FIGS. 7A-7F and 724 in FIGS. 7G-7H, to the container 702. The mechanism may be threads, snap lock, tongue and groove system, compressive fit system and combinations of the same. In a preferred embodiment, the apparatus is configured to paint the photoluminescent composition in a line or predefined shape designed by the characteristics of the aperture head, 722 and 724. The outer wall 712 may be rigid or flexible. The fluid emitting mechanism for a rigid outer wall 712 may be a mechanical pump or plunger, or force due to gravity, and combinations of the same that are capable of providing the photoluminescent composition from the chamber 706 through the device aperture 704. The fluid emitting mechanism for a flexible outer wall 712 may be a manual force due to compression of the outer container wall 712. The chamber 706 is where the photoluminescent composition is held and also where the photoluminescent composition is activated. Activated means providing the photoluminescent composition with energy required to energize the composition so that photoluminescent composition will produce light. The length of time the photoluminescent composition will produce light is known as persistence of the photoluminescent composition as described herein throughout.

A circuit 714 is configured to emit energy, e.g., light, and resides in a portion of the apparatus 700. The light is configured to radiate an inner wall of the container and activate the photoluminescent composition in the chamber 706. The emitted energy will be spread between the inner wall 710 volume 720. In a preferred embodiment, includes one or more light source(s). Examples of an light source is a light emitting diode (LED), halogen lamp, xenon, fluorescent lamp, chemiluminescence device, etc. In a preferred embodiment, the light source emits ultraviolet light, which is configured to activate the photoluminescent composition. In a preferred embodiment, the light source may be rotated to redirected outward to activate the photoluminescent composition not within the chamber 706.

In a preferred embodiment, the aperture head 722 or 724, may be interchangeable. Optionally and/alternatively, the head 722 includes a material including fibers, e.g., a wicking material configured to hold some of the photoluminescent composition and provide to a substrate, e.g., clothes, paper, walls, material, not shown. In FIGS. 7A-7F, the aperture head 722 includes a hollow brush allowing the photoluminescent composition exiting the container 706 through the aperture 704 to be painted on external objects with the brush material. An additional aperture head 724 in FIGS. 7G-7H is a mesh stamp formed into a shape, e. g. star, heart, circle, letter, etc. The stamp may have a mechanism to change the size of the stamp.

In a preferred embodiment, the inner wall 710 includes an energy transparent material configured to allow energy, e.g., light to penetrate or pass through the material and into the photoluminescent composition in the chamber 706 with little or no resistance. The transparent material may include glass, acrylic, polycarbonate, styrene and combinations of the same. In a preferred embodiment the outer wall 712 is made of, coated, or wrapped with reflective materials configure to the light back into the chamber 706 with minimal or no energy loss. In one embodiment, the reflective coating includes one or more chrome, aluminum, silver, gold, platinum, nickel, inconel, and combinations of the same. In a preferred embodiment, the coating is applied to one or more of an inner surface of the outer wall 712 and an outer surface of the outer wall 712. The outer wall 712 may be rigid or flexible to manually push the fluid from the chamber 706 to the aperture 704.

A space 716 is located between the light (not shown), which is part of the circuit 714, and an inner wall 710. In this embodiment, the space 716 is filled with an air medium. Alternatively and/or optionally, the space 716 may be a vacuum space, partially filled or filled with other mediums, e.g., gases, transparent fluids, semisolids or solids such as water, hydrogel, glycerol, glass, acrylic, polycarbonate, styrene, combinations of the same and the like. The gases may be configured to be activated with light, e.g., neon, hydrogen, helium, carbon dioxide, mercury. The gases may be an inert gas. In one embodiment, the space is filed with a transparent media to minimize any light loss between the light source and the inner wall 710. The photoluminescent composition is described herein. Depending on the properties of the photoluminescent composition in the chamber 706, the light may not be able to penetrate completely through the photoluminescent composition.

In a preferred embodiment, the chamber 706 is shaped by the inner wall 710 and the outer wall 712 such the photoluminescent compositions contained within the chamber receives the maximum amount of energy from the light source of the circuit 714. This energy is described as activation energy. In a one embodiment, the distance between the inner wall 710 and outer wall 712 is a range from about 0.01 inch to about 20 inches. In this embodiment, the shortest distance 718 is about 0.01 to about 1 inch. In a preferred embodiment, the distance is in a range from about 0.1-0.25 inch.

In one embodiment, the inner wall 710 and outer wall 712 are configured to form a chamber such that about 0.01% percent of the volume of the composition is activated with the energy from the light substantially simultaneously, in a preferred embodiment, more than 10% of the percent of the volume of the photoluminescent composition is activated with the energy from the light substantially simultaneously, in a more preferred embodiment, more than 25% of the percent of the volume of the photoluminescent composition is activated with the energy from the light substantially simultaneously, in a more preferred embodiment, more than 50% of the percent of the volume of the photoluminescent composition is activated with the energy from the light substantially simultaneously, in a more preferred embodiment, more than about 75% of the percent of the volume of the photoluminescent composition is activated with the energy from the light substantially simultaneously, and in a more preferred embodiment, about 100% of the percent of the volume of the photoluminescent composition is activated with the energy from the light substantially simultaneously.

In a preferred embodiment, the photoluminescent composition includes about 40% phosphorescent particles, about 60% binder or binder/water mixture, e.g., aloe vera, clear body paint, liquid latex, polyvinyl material, or acrylic paint. The composition has a viscosity to prevent the particles from settling and still allow it to be emitted with a fluid emitting device (not shown).

Optionally and/or alternatively, the colloidal suspension of the particles may have a mixing method to prevent settling before emitting at ambient temperatures and/or above; this could be mechanical as a ball or air bubble that would disturb the fluid when the bottle is shaken. The mixer may be electromechanical or adapted in the emitting fluid path.

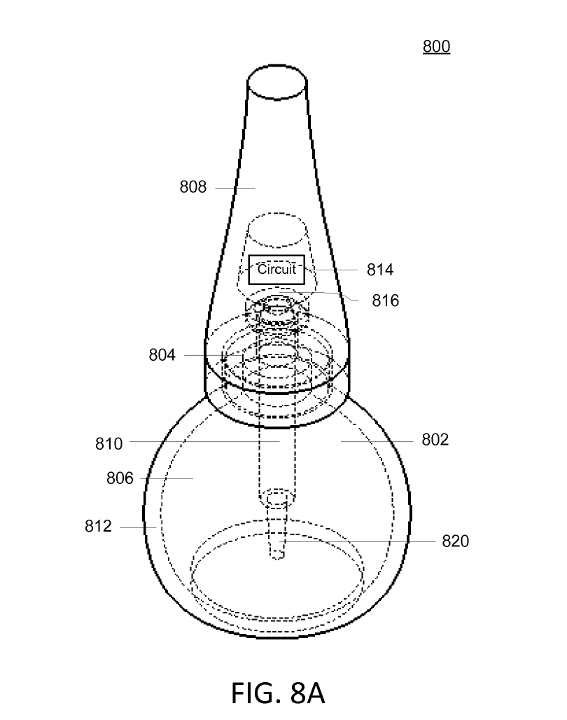

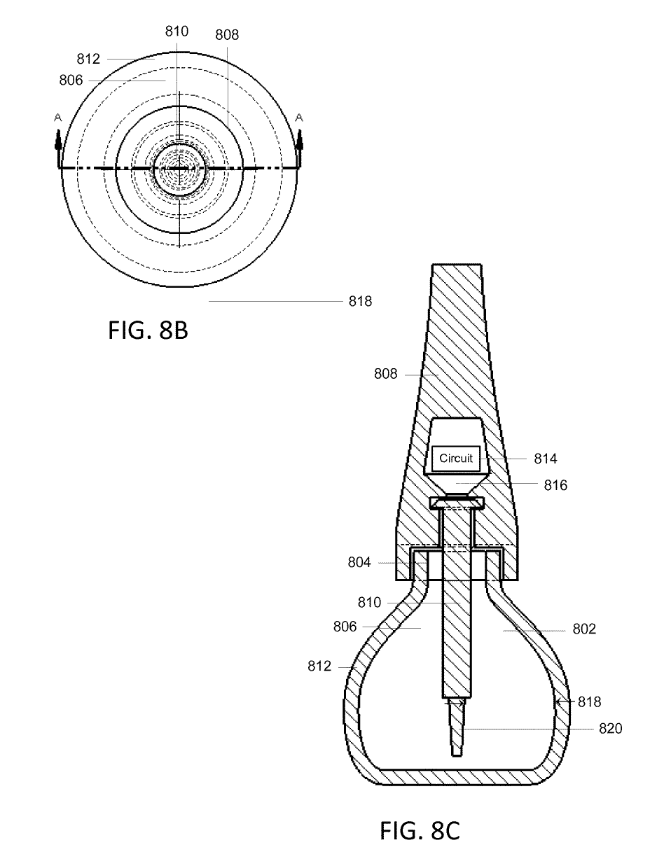

FIG. 8A illustrates an exemplary perspective view of a photoluminescent activator apparatus according to another embodiment of the invention. FIG. 8B illustrates a top view of the photoluminescent activator apparatus according to FIG. 8A. FIG. 8C illustrates a cross sectional view of the photoluminescent activator apparatus according to FIG. 8B along line A-A′.

Referring to FIGS. 8A-8C, the apparatus is generally depicted as number 800. The apparatus 800 includes a container 802, a circuit 814, and dispersal tip 820 in the chamber 806 of the container 802 configured to illuminate and to disperse a photoluminescent composition. The container 802 includes an outer container wall 812 and inner illumination diffuser 810. The aperture 804 may have a mechanism for attaching a container lid 808 to the container 802. The mechanism may be threads, snap lock, tongue and groove system, compressive fit system and combinations of the same. The lid 808 contains a emit energy 814 e.g. light, a illumination diffuser 810, and dispersal tip 820. In a preferred embodiment, the mechanism is configured to paint the photoluminescent composition with the dispersal tip 820 of the apparatus 800. The chamber 806 is where the photoluminescent composition is held and also where the photoluminescent composition is activated. Activated means providing the photoluminescent composition with energy required to energize the composition so that photoluminescent composition will produce light. The length of time the photoluminescent composition will produce light is known as persistence of the photoluminescent composition as described herein throughout.

A circuit 814 configured to emit energy, e.g., light, and resides in a portion of the apparatus 800. In a preferred embodiment, the energy released by the emitted energy 814 travels through the illumination diffuser 810 and dispersal tip 820 to illuminate the photoluminescent composition within the container 806. The emitted energy may or may not be activated when the lid is detached from the container. In a preferred embodiment, the light source includes one or more light source(s). Examples of an light source is a light emitting diode (LED), halogen lamp, xenon, fluorescent lamp, chemiluminescence device, etc. In a preferred embodiment, the light source emits ultraviolet light, which is configured to activate the photoluminescent composition.

In a preferred embodiment, the inner illumination diffuser 810 and dispersal tip 820 includes an energy dispersal material configured to allow energy, e.g., light to penetrate or pass through the material and into the photoluminescent composition in the chamber 806 with little or no resistance. The transparent material may include glass, acrylic, polycarbonate, styrene and combinations of the same. In a preferred embodiment the outer wall 812 is made of, coated, or wrapped with reflective materials configure to the light back into the chamber 806 with minimal or no energy loss. In one embodiment, the reflective coating includes one or more chrome, aluminum, silver, gold, platinum, nickel, inconel, and combinations of the same. In a preferred embodiment, the coating is applied to one or more of an inner surface of the outer wall 812 and an outer surface of the outer wall 812.

A space 816 is located between the light (not shown), which is part of the circuit 814, and an inner wall 810. In this embodiment, the space 816 is filled with an air medium. Alternatively and/or optionally, the space 816 may be a vacuum space, partially filled or filled with other mediums, e.g., gases, transparent fluids, semisolids or solids such as water, hydrogel, glycerol, glass, acrylic, polycarbonate, styrene, combinations of the same and the like. The gases may be configured to be activated with light, e.g., neon, hydrogen, helium, carbon dioxide, mercury. The gases may be an inert gas. In one embodiment, the space is filed with a transparent media to minimize any light loss between the light source and the inner illumination diffuser 810. The photoluminescent composition is described herein. Depending on the properties of the photoluminescent composition in the chamber 806, the light may not be able to penetrate completely through the photoluminescent composition.

In a preferred embodiment, the chamber 806 is shaped by the inner illumination diffuser 810 and the outer wall 612 such the photoluminescent compositions contained within the chamber receives the maximum amount of energy from the light source of the circuit 814. This energy is described as activation energy. In a one embodiment, the distance between the inner illumination diffuser 810 and outer wall 612 is a range from about 0.01 inch to about 20 inches. In this embodiment, the shortest distance 818 is about 0.01 to about 1 inch. In a preferred embodiment, the distance is in a range from about 0.1-0.25 inch.

In one embodiment, the inner illumination diffuser 810 and outer wall 812 are configured to form a chamber such that about 0.01% percent of the volume of the composition is activated with the energy from the light substantially simultaneously, in a preferred embodiment, more than 10% of the percent of the volume of the photoluminescent composition is activated with the energy from the light substantially simultaneously, in a more preferred embodiment, more than 25% of the percent of the volume of the photoluminescent composition is activated with the energy from the light substantially simultaneously, in a more preferred embodiment, more than 50% of the percent of the volume of the photoluminescent composition is activated with the energy from the light substantially simultaneously, in a more preferred embodiment, more than about 75% of the percent of the volume of the photoluminescent composition is activated with the energy from the light substantially simultaneously, and in a more preferred embodiment, about 100% of the percent of the volume of the photoluminescent composition is activated with the energy from the light substantially simultaneously.

In a preferred embodiment, the photoluminescent composition includes about 40% phosphorescent particles and about 60% binder, e.g., aloe vera, The phosphorescent particles may be spherical or oval for makeups like mascara. The composition has a viscosity to prevent the particles from settling and still allow it to be emitted with a fluid emitting device (not shown).

Optionally and/or alternatively, the colloidal suspension of the particles may have a mixing method to prevent settling before emitting at ambient temperatures and/or above; this could be mechanical as a ball or air bubble that would disturb the fluid when the bottle is shaken.

### EXAMPLES

Without intending to limit the scope of the invention, the following examples illustrate how various embodiments of the invention may be made and/or used.

### Example 1

This example 1 illustrates the glowing capability of the novel photoluminescent compositions used in this invention compared to other products on the market.

Four unique photoluminescent compositions outlined in this invention were tested 40% Glo Tech International 45-85 μm natural series pigment (Product Code GT8700) with 60% aloe; 40% Glo Tech International 45-85 μm ocean series pigment (Product Code GTB8700) with 60% aloe; 20% Glo Tech International 45-85 μm greenish yellow pigment (Product Code GT8700) with 40% aloe and 40% water; 20% Glo Tech International 45-85 μm ocean series pigment (Product Code GTB8700) with 40% aloe and 40% water. Additionally, four additional off the shelf products were tested: DecoArt DS50-10 Glow in the Dark Paint; Rust-Oleum 267026 Glow in the Dark Spray; and Astro Glow glow in the dark Paint; Tulip Body Art Face & Body Paint Tube, Natural Glow.

Photoluminescent Pigments come in several color. Both natural (green) and ocean pigments were tested to determine if there is a difference in illumination between colors.

The photoluminescent pigment concentration of the composition may very between 20% and 40%, depending on the application of the product. Both the lower and higher photoluminescent pigment concentrations were tested to determine if there is a difference in illumination between pigment concentration.

Experimental setup: Each of the eight samples tested was put in a one inch square, one inch apart. Each of the samples thickness was similar. The thickness was defined by surrounding each sample square with two layers of 5 mil painter's tape, putting the sample in the cavity then scraping off any access fluid over the tape. This gave each sample roughly a 0.254 mm thickness. The one exception to this method was for the glow in the dark aerosol spray where the manufacturer's instructions were followed.

The samples were placed under a UV tube light, in a dark room with no ambient light, with each sample at equal distance from the light. The samples were charged for two hours. A camera was set directly above the sample board at a height that would capture all the samples in one image. The camera used was a Canon D50. An initial photograph was taken within one minute of removing the activation's light. Additional photographs were taken every 10 minutes until there was no visible light left. The shutter speed was 10 seconds and the aperture was set to F8. These camera settings were selected during pretests to most accurately represent the brightness of the products as observed at the lower illumination with the naked eye.

The images were uploaded and converted to grayscale images through Matlab, 0 to 255 scale. The mean illumination intensity of the center 50 by 50 pixels of each sample were observed in Matlab and plotted on a time scale.

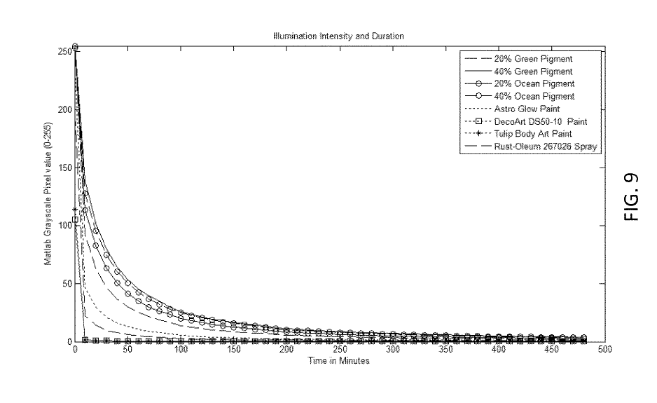

The brightness and duration of the photoluminescent composition presented in this patent exceeded that of off the shelf products. FIG. 9 illustrates the illumination intensity and duration for the first 6 hours of the experiment. After 6 hours All the off the shelf products tested were not visible by the naked eye and the photoluminescent composition discussed here were still visible by the naked eye. The photoluminescent composition were >7% brighter, >55%, and >57% brighter than all the off the shelf products at 0 min, 30 min and 60 min after activation. Table 1 shows the time after activation when mean pixel value dropped below 1 and is similar to when the samples were unable to be seen by the naked eye. The photoluminescent composition presented here illuminated more than 61% longer then the off the shelf products tested.

TABLE 1
Time after activation the sample mean pixel value dropped <1

| | Time after activation the | |
|---|---|---|
| Product or photoluminescent | sample the mean pixel | |
| compositions | value dropped below 1 | |
| 40% Glo Tech International 45-85 μm | Greater than 1220 min | |
| natural series pigment (Product Code | | |
| GT8700) with 60% aloe | | |
| 40% Glo Tech International 45-85 μm | 1130 | min |
| ocean series pigment (Product Code | | |
| GTB8700) with 60% aloe | | |
| 20% Glo Tech International 45-85 μm | 1210 | min |
| greenish yellow pigment (Product Code | | |
| GT8700) with 40% aloe and 40% water | | |
| 20% Glo Tech International 45-85 μm | 1130 | min |
| ocean series pigment (Product Code | | |
| GTB8700) with 40% aloe and 40% water | | |
| DecoArt DS50-10 Glow in the Dark Paint | 10 | min |
| Rust-Oleum 267026 Glow in the Dark | 230 | min |
| Spray | | |
| Astro Glow in the dark Paint | 450 | min |
| Tulip Body Art Face & Body Paint | 10 | min |
| Tube, Natural Glow | | |

While various embodiments of the present disclosure have been described in detail, it is apparent that modifications and alterations of those embodiments will occur to those skilled in the art. However, it is to be expressly understood that such modifications and alterations are within the scope and spirit of the present disclosure, as set forth in the following claims.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the present disclosure has included description of one or more embodiments and certain variations and modifications, other variations and modifications are within the scope of the disclosure, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The invention claimed is:

1. An apparatus for projecting an activated photoluminescent composition, comprising:
a container including a chamber for storing the photoluminescent composition, an aperture for receiving the photoluminescent composition, and optionally, a fluid emitting device coupled to the aperture; and
a light source arranged within the apparatus and configured to activate the photoluminescent composition in the chamber.

2. The apparatus of claim 1, wherein the photoluminescent composition comprises phosphorescent pigment and a binder.

3. The apparatus of claim 1, wherein the light source comprises a light emitting diode.

4. The apparatus of claim 3, wherein the light emitting diode comprises one or more light emitting diodes.

5. The apparatus of claim 1, wherein the fluid emitting device is comprises a piston pump.

6. The apparatus of claim 1, wherein the fluid emitting device comprises a head.

7. The apparatus of claim 6, wherein the head comprises at least one of a fibrous material and a brush material.

8. The apparatus of claim 7, wherein the head comprises at least one of a star type shape and a heart type shape.

9. The apparatus of claim 1, further comprising a power source including one or more of a battery power source, solar power source, inductive power source, AC power source, and DC power source.

10. A method of activating a photoluminescent composition within a photoluminescent activating apparatus, comprising:
obtaining a photoluminescent activating apparatus comprising a container including a chamber for storing the photoluminescent composition, an aperture for receiving the photoluminescent composition, and optionally, a fluid emitting device coupled to the aperture and a light source arranged to emit light within a portion of the container configured to activate the photoluminescent composition in the chamber;
providing the photoluminescent composition into the chamber through at least a portion of the aperture; and
turning on a power source to activate a light source.

11. The method of claim 10, further comprising the step of connecting a fluid emitting device to the aperture.

12. The method of claim 10, further comprising the step of activing the fluid emitting device to emit an activated photoluminescent composition.

13. The method of claim 10, further comprising the step of activing the fluid emitting device to emit an activated photoluminescent composition.

14. The method of claim 10, wherein the photoluminescent composition comprises at least one of aloe, carbomer, and gelatin.

15. The method of claim 10, wherein the light source comprises a light emitting diode.

16. The method of claim 15, wherein the light emitting diode comprises one or more light emitting diodes.

17. The method of claim 10, wherein the fluid emitting device is comprises a piston pump.

18. The method of claim 10, wherein the fluid emitting device comprises a head.

19. The method of claim 18, wherein the head comprises a fibrous material.

20. The apparatus of claim 1, wherein the light source can be removable to insert in a new container.
